(19) United States
(12) Patent Application Publication
(10) Pub. No.: US 2011/0278520 A1
(43) Pub. Date: Nov. 17, 2011

(54) METHOD AND DEVICE FOR HANDLING OF ROPE

(76) Inventor: Per Ingeberg, Ulsteinik (NO)

(21) Appl. No.: 13/146,466

(22) PCT Filed: Feb. 25, 2010
(86) PCT No.: PCT/EP2010/052387

§ 371 Date: Jul. 27, 2011

(30) Foreign Application Priority Data
Feb. 25, 2009 (NO) 20090870

(51) Int. Cl. B66D 1/26; B66D 5/00; F16G 11/08; B66D 1/74; B63B 21/04; B66D 1/38; B23P 11/00

(52) U.S. Cl. 254/281; 29/428

(57) ABSTRACT

A rope handling system for an offshore vessel for handling of synthetic rope (3) for heavy lifting and deployment operations offshore, the system comprising multiple winch drums (11) adopted for housing a predetermined length of rope (3), a spooling system (13, 17) to spool in and spool out rope on the drums (11), a transfer system comprising of sheaves (14, 21, 22) for leading the rope (3) between a drum (11) and a traction winch (15), the traction winch (15) comprising three or more sheaves (30), where the sheaves are arranged so that rope may be arranged from one sheave to the next substantially following a common tangent of the two sheaves and so that the rope rests against about half the circumference of each sheave, and where each sheave operated by an independent motor (32), and where a rope stopper (4) is arranged downstream of the traction winch relative to the drum (11) upstream of the traction winch, is described. A method for handling rope during heavy lifting and deployment operations, and a method for loading rope onto the system are also described.

### TECHNICAL FIELD

The present invention relates to the field of anchor handling in offshore operations. More specifically, the invention relates to improvements in rope handling for pre-set of mooring lines, anchor handling and the like, and to equipment for rope handling onboard an anchor handling vessel.

### BACKGROUND ART

The use of fibre rope is of increasing importance as offshore operations are performed at deeper water depths. In deep waters the use of wire and chain for anchor handling operations, lifting operations and moorings is prohibited by the weight of steel as the self weight of a long wire or chain will reduce the useful capacity of the wire substantially.

When an offshore rig is to be moored in an offshore position especially in deep water or in areas with harsh weather conditions, pre-set moorings are often preferred as it allows the installation of the moorings to be done off the critical path for the rig and the number of days from the rig is in position until the rig is moored is reduced.

For pre-set moorings anchors with anchor-chain and polyester rope segments are installed by means of anchor handling vessels before the rig is in place. The pre-set moorings are buoyed-off. When the rig is in position the buoys are picked up by the anchor handling vessel and connected to the rig chain. The moorings are then tightened by the rig mooring winches.

Pre-set mooring requires anchor handling vessels that can handle polyester mooring lines, in addition to chain and anchors, effectively and without damaging the polyester rope. For deep waters it is also necessary to be able to handle a substantial amount of rope in an effective way. Challenges in these operations are related to several factors. There may be a substantial load in the polyester rope during the installation due to the weight of the anchor and anchor chain suspended at the end of the polyester rope. The rope must be tensioned from a low storage tension a high installation tension. Further, several segments of the polyester rope must be connected together. Big spliced eyes must be handled through the handling system, and connection between two eyes must be performed with a high load suspended in the rope.

Different tools for handling of load, such as anchors or other equipment that are to be lowered from a vessel or hoisted onboard a vessel, are known in the prior art.

A traction winch for synthetic rope is described in U.S. Pat. No. 6,182,915 A (ODIM ASA) 02.06.2001. This traction winch comprises three or more sheaves where the sheaves are arranged so that a rope may be arranged from one sheave to the next substantially following a common tangent of the two sheaves and so that the rope rests against about half of the circumference of the sheave and where each sheave is operated by an independent motor. By means of the independent operation of the sheaves, the force exerted by each sheave on the rope is effectively controlled to avoid local overloading and potential damage to the rope. A drum is provided for storing of the rope but no solution is given for handling of ropes when the total length of rope exceeds the length that may be stored on one drum. At the depths at which it is operated today, rope from several drums has to be connected to give the sufficient effective length of rope. The '915 patent has no solution for connecting ropes from different drums and for connecting ropes under load conditions, or under high tension. Additionally, loading of rope from containers or the like onto drums to be handled onboard a vessel is not mentioned in the '915 patent as the patent only describes the function and the advantages of the traction winch as such. The development towards oil and gas exploitation in increasingly deep waters far from the coast makes it important to have effective solutions for handling of the rope both out at the oil and/or gas field or in the harbour.

The present invention provides solutions that makes it possible to handle large amount of rope in an effective way and that makes it possible to connect ropes when the rope is under great tension in a safe and efficient way.

### DISCLOSURE OF INVENTION

According to a first aspect, the present invention provides a rope handling system for an offshore vessel for handling of synthetic rope for heavy lifting and deployment operations offshore, the system comprising multiple winch drums adopted for housing a predetermined length of rope, a spooling system to spool in and spool out rope on the drums, a transfer system comprising of sheaves for leading the rope between a drum and a traction winch, the traction winch comprising three or more sheaves, where the sheaves are arranged so that a rope may be arranged from one sheave to the next substantially following a common tangent of the two sheaves and so that the rope rests against about half the circumference of each sheave, and where each sheave operated by an independent motor, and where a rope stopper is arranged downstream of the traction winch relative to the drum upstream of the traction winch. The use of a traction winch having several independently controlled sheaves that will distribute the load over all sheaves, and where the rope follows a track between the sheaves that constitutes a common tangent of two sheaves, will give the advantage that an eye at the end of a rope can be pulled through the traction winch under tension without causing damage to the rope or traction winch.

According to one embodiment, one or more manipulator(s) is (are) arranged on cranes to allow action of the manipulator(s) at the aft deck of the vessel. Manipulators arranged on cranes at, or adjacent to the deck, allows for remote controlled manipulations at the deck. The remote controlled manipulators allows for remotely controlled permanent connection of the ropes, i.e. without the necessity of having personnel in high risk zones such as the aft deck for this kind of operations.

According to another embodiment, the rope stopper comprises a rotating member having a substantially vertical axis of rotation, and two substantially vertical pins having a vertical distance greater than the rope to be stopped, arranged at the rotary member. The rope stopper may be designed to be retracted into the deck of the vessel when not in use. This kind of rope stopper gives a rapid and effective locking and unlocking of a rope under tension. The device may be remotely controlled and there is no need for personnel on deck for the operation thereof.

According to a second aspect, the present invention relates to a method for connecting ropes for heavy lifting operations onboard an offshore vessel, where the rope are arranged on a series of winch drums, where the ropes at each end are provided with eyes and where the rope are directed from one winch drum through a traction winch, comprising the following steps:
1. providing a temporary connection between the end of an outgoing rope and a second rope or wire,
2. leading the temporary connected rope and rope or wire are led through the traction winch under tension,
3. locking the outgoing rope at the downstream side relative to the traction winch by means of a rope stopper,
4. providing a permanent connection between an eye at the end of an outgoing rope and an eye at the end a second rope, and
5. releasing the rope lock.

The method provides for a safe and safe method for substituting one drum for another as source for rope during operations requiring longer ropes than lengths that can be stored on one drum.

According to one embodiment of the method, step a) is performed by providing a temporary connection between the outgoing rope and a new rope from another drum, before the ropes are led through the traction winch in step b).

According to an alternative embodiment of the method, step a) is performed by providing a temporary connection between the outgoing rope and a temporary rope or wire, and that a step of leading a rope from another drum through the traction winch, is performed between step c) and step d).

According to a third aspect, the present invention relates to a method for loading rope onto a drum onboard a vessel, the method comprising:
providing a rope onboard the vessel or in proximity of the vessel,
leading a rope end over one or more redirection devices towards and though a traction winch onboard the vessel,
leading the rope from the traction winch to the drum via one or more sheaves and a spooling device, and
spooling the rope onto the drum under tension control by means of the traction winch.

This method provides an effective and safe method for loading rope onboard a vessel, where the rope delivered on a drum or in bulk is brought onboard the vessel and spooled directly onto spools arranged onboard the vessel.

### BRIEF DESCRIPTION OF DRAWINGS

FIG. 1 is a perspective drawing of an anchor handling vessel equipped according to the invention,

FIG. 2 corresponds to the view of FIG. 1 were the vessel as such is erased to illustrate the present rope handling system,

FIG. 3 corresponds to FIG. 2 from a different angle,

FIG. 4 is an illustration of a traction winch that Is a part of the handling system,

FIG. 5 is a detail view of a part of the handling system,

FIGS. 6 a) to 6 h) illustrates the change of rope in the present system,

FIG. 7 is an illustration showing the connection of two ropes

FIG. 8 is a detail view of a rope lock constituting a part of the present system, and

FIG. 9 illustrates loading of rope using the present rope handling system.

### MODE(S) FOR CARRYING OUT THE INVENTION

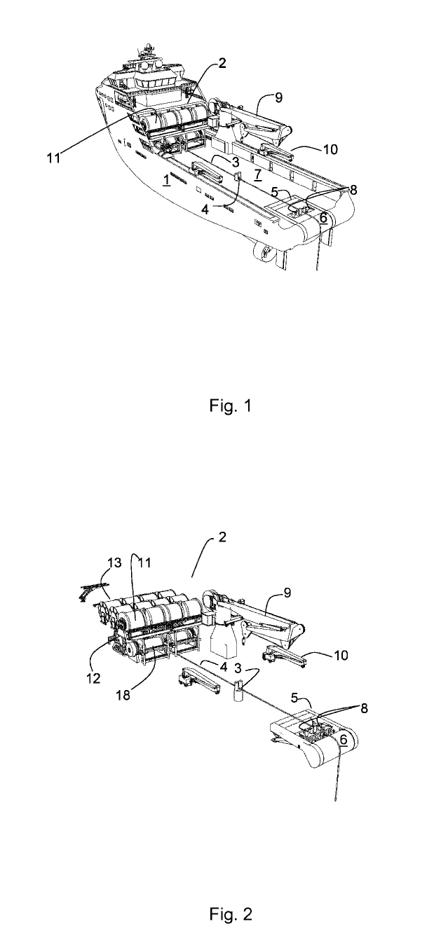

FIG. 1 illustrates is a perspective view seen from the aft port side of an anchor handling vessel 1, seen from port side and astern, the vessel 1 including a rope handling system 2 according to the present invention.

A rope 3 is runs over the working deck 7, from the rope handling system 2 via a rope stopper 4 over a stern roller 6 and into the sea. An anchor handling frame 5 is illustrated at the aft end of the deck 7. The anchor handling device is preferably an anchor handling device according to WO 2009/005367 A (ODIM ASA) 5 Jul. 2009, which is included herein by reference in its entirety. The anchor handling device may be used for the handling of anchors, e.g. traditional anchors and torpedo anchors, and other heavy loads that is to be either brought onboard the vessel or to be brought from the deck and into the sea. In FIG. 1, the anchor handling frame 5 is illustrated in a resting position where it is arranged in recesses in the deck 7 to leave flat working space.

Several locking devices for chains or the like, so called “shark jaws”, and guide pins for cables, wires and chains are all indicated by 8 at the stern part of the deck 7. The shark jaws and guide pins are preferably of the type described in WO 2008/153411 A (ODIM ASA) 18 Dec. 2008, which is included herein by reference in its entirety.

Several cranes 9, 10, are also provided in connection with the deck 7 to handle cargo or the like, or for handling of equipment at the deck 7.

The rope handling system comprises, in addition to elements mentioned above, a plurality of winch drums 11 for the rope. The drums 11 are arranged above the working deck 7 and the rope 3 is directed to a traction winch and sheaves from the deck to the drum 11 that is in use, as will be described further below.

FIG. 2 corresponds to FIG. 1, where the vessel 1 is erased and the deck equipment of interest is kept at correct positions relative to each other, to give a better view of the deck equipment used according to the present invention.

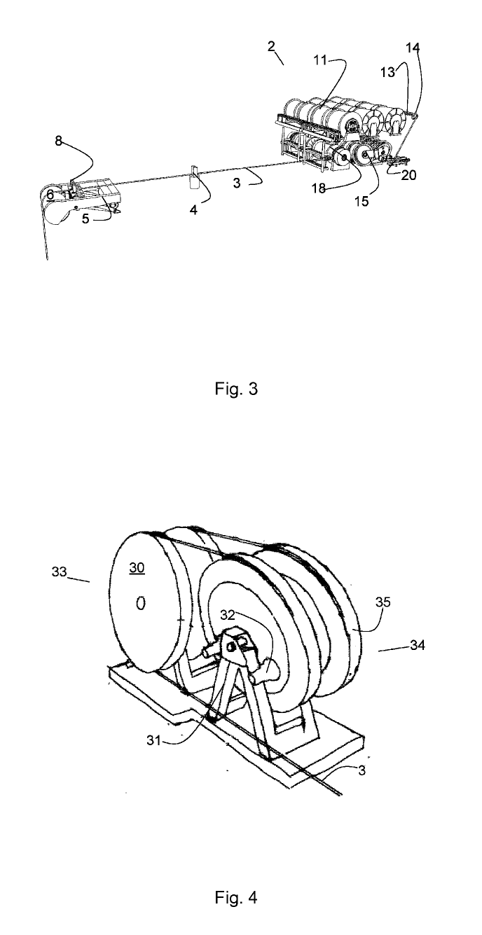

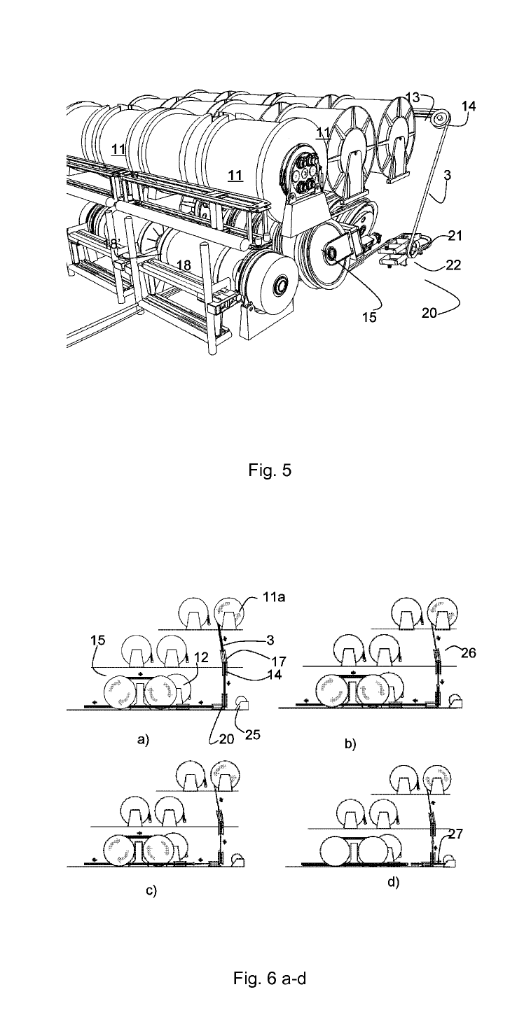

FIG. 3 is a view of the same kind as FIG. 2, but seen from the aft starboard side of the vessel and the cranes 9, 10 are removed for a better view of the remaining equipment.

FIGS. 2 and 3 reveal details that are hidden in FIG. 1 and illustrate the elements of the present invention better than a full view. In FIGS. 2 and 3 it is apparent that a plurality of drums 11 is provided above the working deck 7 for storing of rope 3. The number of rollers is limited only by physical limitations onboard the vessel and in that there must be a practical way to convey the rope from the drums to the working deck from each drum 11. The figures show rollers at one deck, but for some vessels the rollers may be arranged on two or more decks.

One or more primary winch(es) 12 for wire and or rope is(are) preferably provided at the working deck, e.g. as below the drums 11 as illustrated in FIG. 2. The primary winch(es) 12 may be used for several tasks onboard the vessel, as illustrated below during rope handling, or for lifting operations.

One or more combined chain and wire winch(es) 18 may be provided at the working deck 7, e.g. as illustrated in FIGS. 2 and 3, for handling of wire and/or chain. The winch 18 preferably also comprises a chain wheel 18′ at one end facing the centerline of the vessel for handling of a chain.

An important part of the present invention is a traction winch 15 for handling of synthetic rope. The traction winch is preferably a traction winch according to the above mentioned U.S. Pat. No. 6,182,915.

FIG. 4 illustrates one embodiment of a traction winch according to U.S. Pat. No. 6,182,915. The traction winch comprises several sheaves 30 each mounted on a supporting member 31. Each sheave has its own propulsion unit 32, e.g. a hydraulic or electric motor turning the sheave 30 by means of a not shown gear rim. It is of great importance that the propulsion for each sheave 30 is separate and that power of and speed of propulsion may be separately adjusted for each sheave 30.

The sheaves 30 are preferably arranged in parallel rows 33, 34 of sheaves 30, even though e.g. the drums at the incoming side and/or outgoing side of the traction winch may be differently arranged. The sheaves in each row 33, 34 are displaced relative to each other both radial and axial so that the radii are mainly parallel to each other. The axis of rotation of the sheaves in the same row 33, 34 are thus preferably substantially parallel and are angled relative to an imaginary straight line between the centres of the drums. The radial distance between two adjacent drums 30 in the same row is preferably constant, and the radial distance in the first row 33 is preferably equal to the radial distance in the other row 34.

A cable or rope 3 entering the traction winch seen from astern is first placed on a first sheave 30, in one of the rows, 33, 34. The cable is placed around about one half of the circumferential surface of the sheave 30. The sheave 30 is preferably provided with a groove 35 to ensure centring of the cable on the circumferential surface. From the first sheave, the cable 3 is led to the nearest sheave in the other row to bear against half of the circumferential surface on this sheave. The cable 3 is then led in the same way between the rows 33, 34.

To avoid sideways forces on the cable 3 in the transition from one sheave to the next drum, the sheaves in the respective rows are tilted relative to each other so that the cable is running in an approximate helical way through the device without being pressed against the sidewalls of the groove 35. To avoid stress on the rope or cable 3 leaving one sheave 30 and entering the next, the sheaves are arranged so that the rope or cable follows a common tangent of the two sheaves 30.

The number of sheaves 30 in the traction winch may be varied according to the demand and available space. The device must have at least two drums whereas there is no upper limit. A large number of drums will ensure that the tension in the cable is distributed on several drums, such as from 4 to 10. The number of sheaves 30 may be even or uneven numbers depending on the required configuration. The number of sheaves that are recommended is also dependent on the difference of tension between the high tension side (i.e. out from the deck of the vessel) and the low tension side (i.e. towards the sheaves 11).

The diameter of the drums 30 also has to be larger than the smallest allowable curvature for the rope 3 at the maximum tension for the rope.

The rope leaving the traction winch is led over a redirection unit 20 comprising one or more sheaves, such as two or three sheaves to redirect the rope from the output direction from the traction winch toward spooling apparatus to spool the rope onto, or from a drum 11. In the device illustrated in the figures, the redirection unit comprises two sheaves 21, 22, the first sheave 21 redirecting the rope parallel to the deck 7, and the second sheave 22, directing the rope upwards from the deck 7 to a sheave 14 redirecting the rope in a direction substantially parallel to the axis of rotation of the drum 11 onto which the rope is arranged. A spooling sheave 17 arranged on a track 13 parallel to the axis of the drum 11, is arranged to control the spooling and unspooling of the rope on the drum 11.

Sheave 21 is preferably an inboard damping device, i.e. the sheave is displaceable arranged and is connected to a damper, such as e.g. an hydraulic dampener, to provide damping to facilitate synchronisation between the traction winch and the active drum 11. Additionally, the sheave 21 including damping may be used for redirection of a rope between the traction winch and the winch 12 and to synchronise the traction winch and the winch 12, when the traction winch is used for lifting purposes.

For optimal storage capacity, or to allow a maximum number of drums 11, it is important to fill or empty the drums in a correct sequence. Alternatively, or in addition to this, the sheave 22 may be arranged on a displaceable rack 23 to allow displacement parallel to the length axis of the vessel of the sheave 22 to allow easy excess to the different drums 11 if the geometry of the vessel requires so.

At the other side, the tension at the high tension side of the traction winch may be more than 10 times the tension on the low tension side thereof, or the side closest to the drums 11. If the tension at the low tension side of the traction winch is lost, the rope may slip in the traction winch resulting in uncontrolled slip of the load, and even damage to the rope.

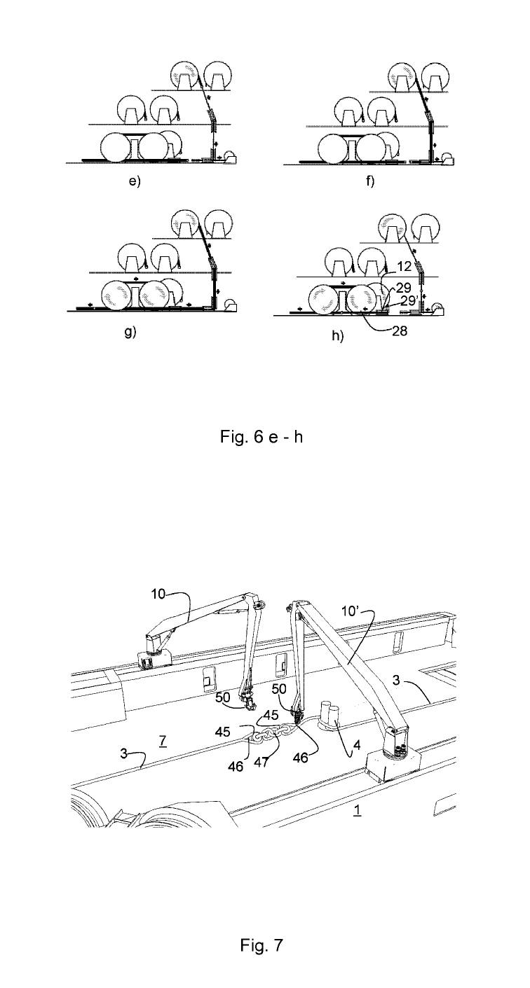

To avoid problems related to the change of drum two methods for change of drum has been developed. A problem to be solved is that the existing methods for changing of ropes requires that the rope is locked at the high tension side when the end of a first rope is drawn through the traction winch as an eye at the end of a rope connected to a strap or to an eye at the end of another rope cannot be drawn under tension through a standard traction winch. This problem has been solved by means of two versions of a novel method according to the present invention. The two versions will be explained below, by means of steps illustrated in FIGS. 6a to 6h.

FIG. 6a illustrates the starting position where a rope 3 is unspooled from a first drum 11a via sheaves 17, 14, the redirection device 20 via the traction winch 15.

In FIG. 6b the end of the rope is reached and a forerunner 26 connecting the rope to the drum 11a is drawn by the rope through the sheaves until the end of the rope 3 reaches a point between the redirection device and the traction winch. In this position the rope, having an eye provided at the end thereof, is fastened with a strap to hold it in position. The forerunner is then disconnected from the rope and connected to a wire 27 from an auxiliary winch 25. The forerunner 26 is then spooled up onto the drum 11a pulling the wire 27 up to the drum.

The wire 27 is then disconnected from the forerunner 26 and connected to an eye of a rope on a second drum 11b. The wire 27 is then drawn back by the auxiliary winch 25 as illustrated in FIGS. 6e and 6f. When the rope 3 from the drum 11b has been drawn trough the redirection device 20, the eyes of the first and second rope 3 may be connected by a strap and the ropes and the strap connecting them may be drawn trough the traction winch. To be able to do so the sheaves 30 of the traction winch are sufficiently wide to allow the eyes of the ropes and the strap to pass. The sheaves 30 of the traction unit have separate propulsion units 32 and the rotational speed of the sheaves 30 are controlled individually to allow the eyes to pass through the traction unit without damage to the rope.

After the connection between the ropes has passed the traction winch and reached the aft deck, as illustrated in FIG. 6g, the ropes are connected in a more permanent way as will be described in further detail below.

FIG. 6h illustrate a second embodiment of the exchange of drums, where the ropes are not connected before the ropes are drawn through the traction winch. According to this second embodiment, the steps illustrated in FIGS. 6a to 6c are the same. In step 6c, the outgoing rope is, however, not fastened by a strap, but connected to a wire or rope 28 connected to the winch 12 via a sheaves 29, 29′. The rope is then allowed to pass through the traction winch before the rope is fastened at the aft deck, as described in further detail below. The forerunner is connected to a wire from the auxiliary winch as described with reference to the first embodiment, and the second rope is pulled down to the working deck and through the redirection device as described above. The second rope is then connected to a rope that is already treaded through the traction winch to pull the first end of the second rope to the aft deck to be connected with the second end of the first rope.

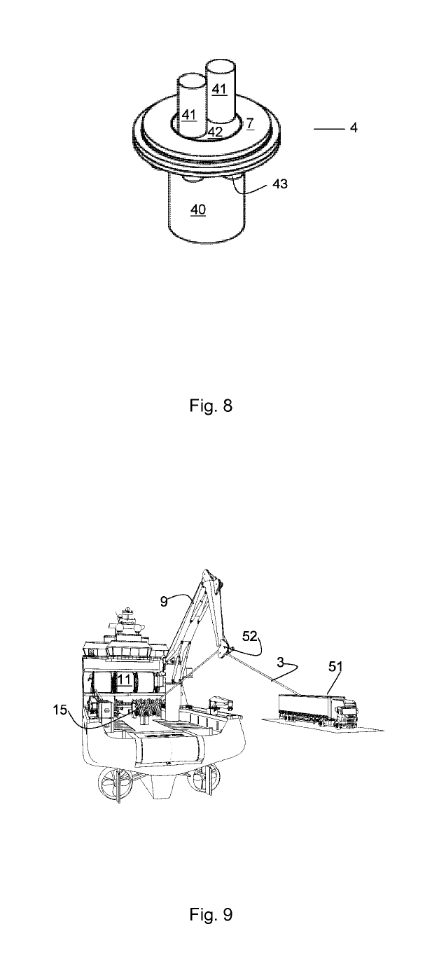

FIG. 7 illustrated the permanent connection of the first and second rope after changing drum 11 as source for the rope. The outgoing rope 3 extends over the aft end of the vessel and is stopped by means of a rope stopper 4. The rope stopper 4 is shown in further detail in FIG. 8. The rope stopper comprises two substantially vertical pins 41 having a distance greater than the diameter of the rope 3 to be stopped, arranged on a rotary member 42. The rotary member may be rotated by means of one or more electrical or hydraulic motors 43 arranged below deck 7. A base member 40 is arranged below the deck 7 and is designed to house the rotating member 42 and the pins 41 when the locking device is not in use. The base member also comprises means to lower and lift the rotary member and pins, such as a hydraulic or mechanical hoisting device.

When the locking device is to be used, the rotating member 42 and pins 41 are lifted up from the base member having the pins 41 arranged one at each side of the rope to be stopped. The rotating member is then rotated a few times, such as one to five turns and then stopped. The rope is then twisted about the pins locking the rope and avoiding the rope to be pulled out by the weight connected to the rope.

After the first rope is locked, connection members 45, e.g. shaped as sheaves to avoid sharp bends, is inserted into the eyes 46 at the end of the ropes 3. The connection members 45 are connected by means of a short piece of chain 47 comprising a number of chain links. The number of chain links may vary but are typically from two to ten chain links.

Preferably, the connection between the ropes is performed without the need to have personnel at the aft deck. Manipulators 50, 50′ are arranged at the end of the outer arms of the cranes 10, 10′. The cranes and the manipulators may then be remotely controlled for the operation of connecting the ropes.

After the ropes have been connected in this way, the traction winch is used to tighten the ropes between the rope stopper and the traction winch. When the rope is tightened, the rope stopper is unwinded to unlock the rope. During the unwinding the traction winch pulls in the unwinded rope until the rope stopper is unwinded and the traction winch has taken over the full tension of the rope. The operation by letting out a load, such as an anchor and/or anchor chain may then continue.

To use the primary winch 12 for heavy lifting operations, the rope or wire at the drum of the winch 12 is led through the traction winch 15 over sheaves 29, 29′ for redirecting of the rope. After passing through the traction winch 15, the rope or wire 28 from the primary winch 12 may be used for different lifting or pulling tasks.

The device according to the invention is also useful in loading rope onboard a vessel. The present device allows the rope to be delivered without necessarily being wound up on drums that are hoisted onboard in exchange of empty drums. FIG. 9 illustrates the loading of rope from a truck 51. The rope may, however, be delivered from another boat, in a container or in any other convenient way. A first end of the rope is brought onboard and is pulled through the traction winch mainly as described above by means of a rope or wire that is treaded through the traction winch and that is pulled by the auxiliary winch or the winch 12. The rope is lead through one or more sheaves from its original position to the traction winch. In FIG. 9 a sheave 52 is arranged at the outer end of the crane 9. The rope 3 is then spooled to a drum by the opposite action as described with reference to unspooling of the rope, by means of the drum. The traction winch is pulling the rope from the truck and provides the resistance necessary to give the correct tension to the rope during spooling.

The present invention has above been described with reference to a specific embodiment and a specific geometric configuration of the vessel and the equipment. The skilled man will, however, understand that the relative arrangement of the different parts of the present device, is dependent on a specific design. The same advantages may, however, also be obtained by an alternative arrangement of some of the elements of the device. The drums 11 are described to be arranged over the working deck. This is a normal configuration. The drums 11 may, however, be arranged in any position onboard the vessel where it is possible, or practical to place the drum and to lead the rope in an effective and practical way between the drum and the traction winch. If the space onboard the vessel allows so, the drums may be arranged over or below the level of the working deck, and even at the same level.

1. A rope handling system for an offshore vessel for handling of synthetic rope (3) for heavy lifting and deployment operations offshore, the system comprising multiple winch drums (11) adopted for housing a predetermined length of rope (3), a spooling system (13, 17) to spool in and spool out rope on the drums (11), a transfer system comprising of sheaves (14, 21, 22) for leading the rope (3) between a drum (11) and a traction winch (15), the traction winch (15) comprising three or more sheaves (30), where the sheaves are arranged so that rope may be arranged from one sheave to the next substantially following a common tangent of the two sheaves and so that the rope rests against about half the circumference of each sheave, and where each sheave operated by an independent motor (32), and where a rope stopper (4) is arranged downstream of the traction winch relative to the drum (11) upstream of the traction winch.

2. The system according to claim 1, wherein one or more manipulator(s) (50) is (are) arranged on cranes (10, 10′) to allow action of the manipulator(s) at the aft deck of the vessel.

3. The system according to claim 1 or 2, wherein the rope stopper (4) comprises a rotating member (42) having a substantially vertical axis of rotation, and two substantially vertical pins (41) having a vertical distance greater than the rope to be stopped, arranged at the rotary member (42).

4. The system according to claim 3, wherein the rope stopper (4) is designed to be retracted into the deck of the vessel when not in use.

5. A method for connecting ropes for heavy lifting operations onboard an offshore vessel, where the rope are arranged on a series of winch drums, where the ropes at each end are provided with eyes and where the rope are directed from one winch drum through a traction winch, characterised in comprising the following steps:
a) providing a temporary connection between the end of an outgoing rope and a second rope or wire,
b) leading the temporary connected rope and rope or wire are led through the traction winch under tension,
c) locking the outgoing rope at the downsteam side relative to the traction winch by means of a rope stopper,
d) providing a permanent connection between an eye at the end of an outgoing rope and an eye at the end a second rope, and
e) releasing the rope lock.

6. The method of claim 5, wherein the step a) is performed by providing a temporary connection between the outgoing rope and a new rope from another drum, before the ropes are led through the traction winch in step b).

7. The method of claim 6, wherein the step a) is performed by providing a temporary connection between the outgoing rope and a temporary rope or wire, and that a step of leading a rope from another drum through the traction winch, is performed between step c) and step d).

8. A method for loading rope onto a drum onboard a vessel, the method comprising:
providing a rope onboard the vessel or in proximity of the vessel,
leading a rope end over one or more redirection devices towards and though a traction winch onboard the vessel,
leading the rope from the traction winch to the drum via one or more sheaves and a spooling device, and
spooling the rope onto the drum under tension control by means of the traction winch.
